(19) United States
(12) Patent Application Publication
(10) Pub. No.: US 2004/0234416 A1
(43) Pub. Date: Nov. 25, 2004

(54) Centrifugal separator

(76) Inventor: Yuichi Shimoyama, Tokyo (JP)

Correspondence Address: NIXON & VANDERHYE, PC, 1100 N GLEBE ROAD, 8TH FLOOR, ARLINGTON, VA, 22201-4714, US

(21) Appl. No.: 10/689,531

(22) Filed: Oct. 21, 2003

(30) Foreign Application Priority Data
May 20, 2003 (JP) 2003-127002

(51) Int. Cl. G01N 9/30

(52) U.S. Cl. 422/72

(57) ABSTRACT

The present invention relates to a centrifugal separator in which a sampling-container locking part connected to the rotary shaft of a motor is rotated with the rotation of the motor driven by a dry cell. The sampling-container locking part includes a connecting part that connects to the rotary shaft and tongue pieces arranged to project oppositely at an angle of at least about 10 to 60 degrees from the upper flat part of the connecting part, with the connecting part interposed therebetween, each having a hole capable of locking a sampling container. The motor is rotated, with the sampling container inserted in the hole, to thereby centrifuge a sample in the sampling container.

### BACKGROUND OF THE INVENTION

1. Field of the Invention

The present invention relates to a centrifugal separator indispensable to study and experiment for centrifuging blood, body fluids and so on to obtain samples used for tests and experiments and, more particularly, relates to a compact centrifugal separator capable of multiple centrifugal separations at a time.

2. Description of the Related Art

In the history of clinical examinations, in order to find hemodynamics, the most important and high-usage test materials for analyzing biological components such as blood and body fluids used for clinical examinations in medical facilities and so on are, for example, supernatant serum or plasma blood separated from blood by a centrifugal separator. The blood centrifugal separators installed in medical facilities are large and use a 100-V power supply.

On the other hand, small-scale medical clinics and local facilities have not such large-sized blood centrifugal separators, thus having difficulty in correct blood sampling.

In addition, recent examples of blood sampling machines include those disclosed in Japanese Unexamined Patent Application Publication Nos. 2001-321364 and 2001-229294 and Japanese Registered Utility Model No. 3073294.

Japanese Unexamined Patent Application Publication No. 2001-321364 describes: a serum sampling container in which a serum sampling container with a filter for holding blood clots is mounted to a blood container and the whole container is turned over to render serum to flow into the serum sampling container; a serum sampling container in which a serum sampling container with a capillary tube is mounted to a blood container and serum is rendered to flow into the serum sampling container by capillarity; and a serum sampling container in which a blood container and the serum sampling container are connected to each other with a serum-absorbing capillary tube and serum is moved to the serum sampling container by pressure.

Japanese Registered Utility Model No. 3073294 describes a simple blood centrifugal separator for collecting serum by centrifugal separation, including a blood sampling container for simply dropping and housing collected blood, which has means for liquating serum by rapid blood coagulation using a coagulating agent and a separating agent for separating a blood clot and serum from each other.

Such a simple blood centrifugal separator is as small as about 5.3 cm in disk radius and is capable of mounting at most four blood sampling containers in the disk. FIG. 3 further shows a state in which when the lid of a so-called planar simple blood centrifugal separator is opened, there is a flat-disk-shaped rotary plate having a mounting part capable of laterally mounting the blood sampling container.

Furthermore, the planar simple blood centrifugal separator has a small motor driven by a commercially available dry cell, which is so-called a rotary-plane compact simple blood centrifugal separator.

Japanese Unexamined Patent Application Publication No. 2001-229294 also discloses a simple blood centrifugal separator including a flat-disk-shaped rotary plate having a mounting part capable of laterally mounting a blood sampling container when the lid of the separator is opened.

In addition, simple methods of blood self-collection without using the centrifugal separator include a blood test method in which blood is permeated into filter paper and it is then collected. This causes incorrect sampling because blood is dried to coagulation during testing and so it becomes difficult to accurately collect test samples from the coagulated blood.

The foregoing are blood centrifugal separators used in human blood testing. However, for the blood testing and body fluid testing for animals including domestic animals, large-sized testing equipment for use in human bodies costs to much; therefore, in present circumstances, the blood testing and body fluid testing are not conducted except in particular cases.

As described above, although the centrifugal separators used in medical facilities or the like are suitable for mass processing, they are expensive and too heavy to carry. Furthermore, they need 100-V power supply, and thus they cannot be easily used at local facilities.

For this reason, the above-described Japanese Unexamined Patent Application Publication No. 2001-321364 and Japanese Registered Utility Model No. 3073294 have been proposed. The centrifugal separator disclosed in Japanese Unexamined Patent Application Publication No. 2001-321364 is used to spontaneously separate serum but is difficult to use for blood clots, thus needing a solution and improvement in the accuracy of separation. It also has a disadvantage in that it is difficult to accurately sample a minor quantity of blood.

Japanese Registered Utility Model No. 3073294 is of planar rotary plate type, thus having difficulty in collecting a supernatant after centrifugal separation of a minor quantity of blood to cause a complicated procedure in testing.

Therefore, although accurate sampling is required for highly accurate testing, the complicated procedure at the time of collecting the supernatant and testing disadvantageously prevents accurate sampling.

Japanese Unexamined Patent Application Publication No. 2001-229294 also has the same drawbacks as those of the Japanese Registered Utility Model No. 3073294 and in which only one thief tube can be placed on the disk, thus taking a lot of time for multiple processings.

With the rotary-plane centrifugal separators, since the thief tube is detachably placed laterally, it takes much time and labor for detachment; thus, a centrifugal separator with an easily detachable thief tube has been desired.

As described above, a solution different from the foregoing has been awaited which is inexpensive and can be used for collecting blood and testing body fluids not only in small-scale clinics but also in a local place, and furthermore, which allows samplers to collect their own blood and to separate it for testing.

Another solution has been awaited which allows blood separation in a short time after collection, thereby allowing accurate sampling.

Still another solution has been awaited which allows efficient separation of a minor quantity of blood, which allows effective and simple blood centrifugal separation so that a blood clot after the centrifugal separation can also be used, and which allows multiple centrifugal separations at a time.

Since this centrifugal separator is small, it is necessary to increase the efficiency of centrifugal rotation. Accordingly, a special compact centrifugal separator has been awaited.

Another testing has also been desired which uses a blood clot, or the residue after blood separation.

Further another solution has been awaited because if the blood and body fluids of animals including domestic animals can be separated inexpensively and easily in addition to the human blood and body fluids, the test for animals can be expanded to allow early detection of diseases and safety of edible animals.

Another centrifugal separator has been desired which is capable of accurate sampling because it is necessary to overcome the drawbacks of too much expenses and labors for animal blood testing and so on and also to increase the accuracy of the testing.

### SUMMARY OF THE INVENTION

In order to solve the above problems and achieve the intended objects, a centrifugal separator according to a first aspect of the present invention is provided which includes a main body including a motor and a dry cell serving as a driving power supply; and a sampling-container locking part connected to the rotary shaft of the motor and capable of locking a sampling container. The sampling container locked to the sampling-container locking part is rotated by the rotation of the motor. The sampling-container locking part comprises a connecting part capable of connecting to the rotary shaft and tongue pieces projecting oppositely with the connecting part interposed therebetween. The tongue pieces are arranged to project from the upper flat part of the connecting part at an angle of at least about 10 to 60 degrees and each have a hole capable of locking the sampling container.

In this case, the tongue pieces projecting oppositely with the connecting part interposed therebetween may have the same shape.

The tongue pieces projecting oppositely with the connecting part interposed therebetween may be at least a pair of tongue pieces.

In order to solve the above problems, a centrifugal separator according to a second aspect of the present invention is provided which includes a main body including a motor and a dry cell serving as a driving power supply; and a sampling-container locking part connected to the rotary shaft of the motor and capable of locking a sampling container. The sampling container locked to the sampling-container locking part is rotated by the rotation of the motor. The sampling-container locking part comprises a connecting part capable of connecting to the rotary shaft and an odd number of tongue pieces projecting from the connecting part. The odd number of tongue pieces are arranged to project radially at regular intervals in the connecting part. The tongue pieces are arranged to project from the upper flat part of the connecting part at an angle of at least about 10 to 60 degrees and each have a hole capable of locking the sampling container.

In this case, the projecting tongue pieces may have the same shape. This allows well-balanced centrifugal separation, offering an advantage.

The centrifugal separator may include a locking member capable of locking the sampling container in place of the hole capable of locking the sampling container. This allows the sampling container to be effectively retained, increasing the efficiency of centrifugal separation of the test object in the sampling container.

Furthermore, the tongue pieces may be arranged to project from the upper flat part of the connecting part at an angle of at least about 45 degrees. This allows the test object to be centrifuged onto one point of the sampling container, facilitating efficient separation of, for example, test blood into serum and a blood clot and also efficient and accurate collection of the separated samples.

The main body may further include an openable and closable lid for closing the sampling-container locking part connected to the rotary shaft; and a safety system that stops power supply to the motor upon the opening of the lid and is capable of power supply to the motor with the main body covered with the lid. This allows safe centrifugal separation.

The centrifugal separator may further include a timer for controlling motor driving time to stop the driving of the motor after a lapse of a specified time interval from the start of motor driving, thereby completing centrifugal separation. This allows the most suitable time for centrifugal separation to be set.

The centrifugal separator may be a blood centrifugal separator. This allows efficient and reliable separation of blood into serum and a blood clot.

The centrifugal separator may be a body-fluid centrifugal separator. This allows the similar collection of samples for tests and experiments.

The centrifugal separator may be a blood centrifugal separator for the blood of animals including domestic animals. This facilitates and expands blood tests for animals including domestic animals in addition to the tests of human blood and body fluids.

The centrifugal separator may be a centrifugal separator for the body fluids of animals including domestic animals.

### BRIEF DESCRIPTION OF THE DRAWINGS

FIG. 1 is a sectional view of a centrifugal separator according to a principal embodiment of the present invention;

FIG. 2 is a sectional view of the centrifugal separator of FIG. 1, showing a state in which a lid is closed.

FIG. 3 is a diagram showing an example of a dry-cell mounting part that is a power-supply container of the centrifugal separator according to the invention;

FIG. 4 is a sectional view of a centrifugal separator according to another embodiment of the present invention;

FIG. 5 is a sectional view of a sampling-container locking part shown in FIGS. 1 and 2;

FIG. 6 is a plan view of the sampling-container locking part shown in FIG. 5;

FIG. 7 is a perspective view of the centrifugal separator according to the invention shown in FIGS. 1 and 2;

FIG. 8 is a plan view of a sampling-container locking part according to another embodiment;

FIG. 9 is a sectional view of the sampling-container locking part shown in FIG. 8;

FIG. 10 is a sectional view of a centrifugal separator including the sampling-container locking part shown in FIGS. 8 and 9; and

FIG. 11 is a plan view of a sampling-container locking part according to another embodiment.

### DESCRIPTION OF THE PREFERRED EMBODIMENTS

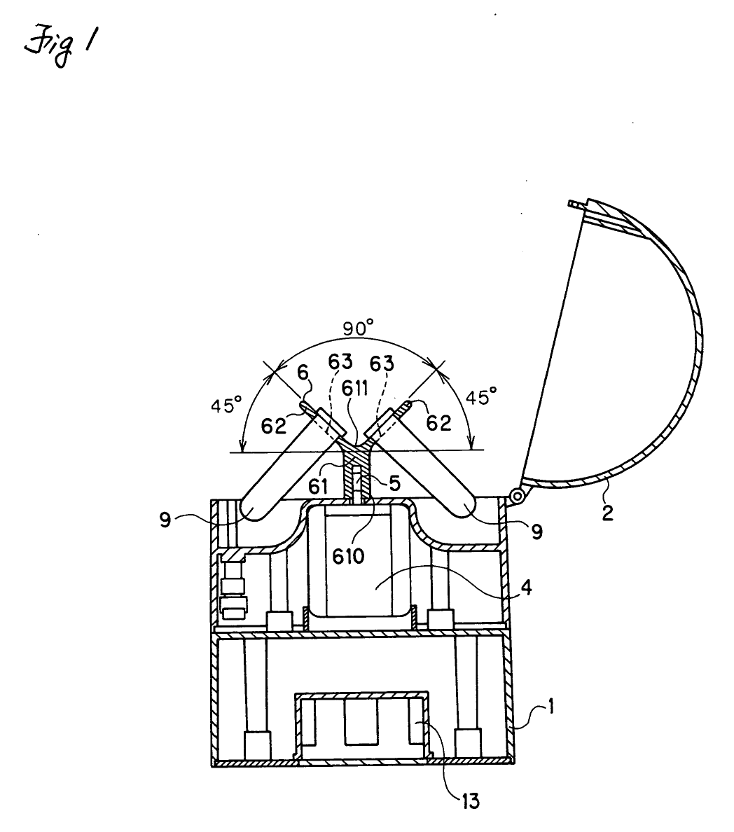

FIG. 1 shows a centrifugal separator in section according to a principal embodiment of the present invention.

A centrifugal separator main body 1 is substantially compact and shaped like a cylinder. The main body 1 has a dry-cell mounting part 13 at the lower part, into which a dry cell 30 which is a power supply 3 can be inserted. The main body 1 has a motor 4 in the center. A rotary shaft 5 connecting to the motor 4 projects upward relative to the shaft center of the main body 1.

The main body 1 has a domical lid 2 connected thereto. The lid 2 is closably arranged on the top of the cylindrical main body 1 so as to cover the projecting rotary shaft 5.

A sampling-container locking part 6 is in engagement with the rotary shaft 5. The sampling-container locking part 6 includes a connecting part 61 having a shaft-inserting part 610 in which the rotary shaft 5 is fitted and tongue pieces 62 projecting from the connecting part 61.

The tongue pieces 62 are substantially shaped like shear legs opposed to each other with the connecting part 61 interposed therebetween for locking sampling containers 9. The shear-leg tongue pieces 62 of the sampling-container locking part 6 each have a hole 63 into which the sampling container 9 can be inserted and can be retained in the vicinity of the opening of the sampling container 9.

The sampling container 9 is locked to the rotary shaft 5 at an inclination of about 45 degrees. In the drawing, the tongue pieces 62 are each arranged at an inclination of about 45 degrees with respect to an upper flat part 611 of the connecting part 61.

Therefore, the sampling container 9 rotates around the rotary shaft 5 in such a manner that the sampling-container locking part 6 is fitted in the rotary shaft 5, the sampling container 9 is inserted into the hole 63 in the tongue piece 62 of the sampling-container locking part 6, the lid 2 is closed, and the motor 4 is then driven.

Accordingly, since the sampling container 9 is retained at an angle, the main body 1 itself can be reduced in size, particularly in width.

With such an arrangement, when the blood in the sampling container 9 is centrifuged by the centrifugal separator according to the invention, blood clots can be collected onto the bottom of the sampling container 9 by the rotation of the centrifugal separation, thus not only facilitating the centrifugal separation of blood but also completely separating serum and blood clots from each other, thereby allowing the serum and the blood clots to be sampled in a separated condition even after the sampling container 9 is taken out from the centrifugal separator.

The blood clots gather on the bottom of the sampling container 9, thus facilitating the collection of only the blood clots. In other words, the separated serum can be used for a first test and the blood clots gathered on the bottom of the sampling container 9 can be easily collected therefrom for testing.

With the conventional horizontal-installation blood centrifugal separators, blood clots gather on the bottom of the sampling container and serum is collected thereon during centrifugal separation. The horizontal installation causes the sample to be adhered to the lid and the wall of the sampling container, making it difficult to collect the sample and tending to cause deterioration thereof. Therefore, it is unsuitable for accurate testing and collection of experimental samples.

Therefore, it may hinder accurate collection for the sampling of only serum and only blood clots.

With the centrifugal separator according to the invention, the sampling-container locking part 6 has the tongue pieces 62 substantially shaped like shear legs opposed to each other. Thus, since the centrifugal force of the sampling containers 9 is applied to the opposite directions with the rotation, both of them balance the centrifugal force.

This prevents a deviational centrifugal force along with the rotation, thus reducing the load on the motor 4, increasing a centrifugal force to samples such as blood in the sampling containers 9 along with weight reduction and rotation of the main body 1 to allow efficient short-time separation and to facilitate the collection of samples.

In FIG. 1, the sampling containers 9 are each locked to the sampling-container locking part 6 with the hole 63; however, the sampling container 9 may be locked with a locking member 64 such as a clamp or a locking piece.

The invention may include a timer (not shown) for controlling the driving time of the motor 4.

For example, while the motor 4 is driven when a switch is turned on, the use of a timer set to drive the motor 4 for, for example, three minutes allows the time of driven centrifugal separation to be controlled, thus allowing the control of optimum and efficient centrifuging time for centrifugal separation.

The time to obtain the samples of serum and a blood clot from blood as a test object is optimally from three to four minutes under the present circumstances. Therefore, it is most suitable to use a timer that stops automatically after a lapse of three minutes and 30 seconds.

In this description, although blood is used for the test object to obtain a sample by centrifugal separation, it is not limited to that; body fluids may be centrifuged and also the samples of various animals including domestic animals such as cattle, horses, sheep, goats, fowls, and hogs, pets such as dogs, cats, birds, and various reptiles, and semidomestic animals in a zoo may be collected for testing and experiment.

Of course, in addition to the animals, the invention may be applied to the centrifugal separation of sap of plants.

Furthermore, the centrifugal separation according to the invention may be applied to the mixture of various test fluids and other substances.

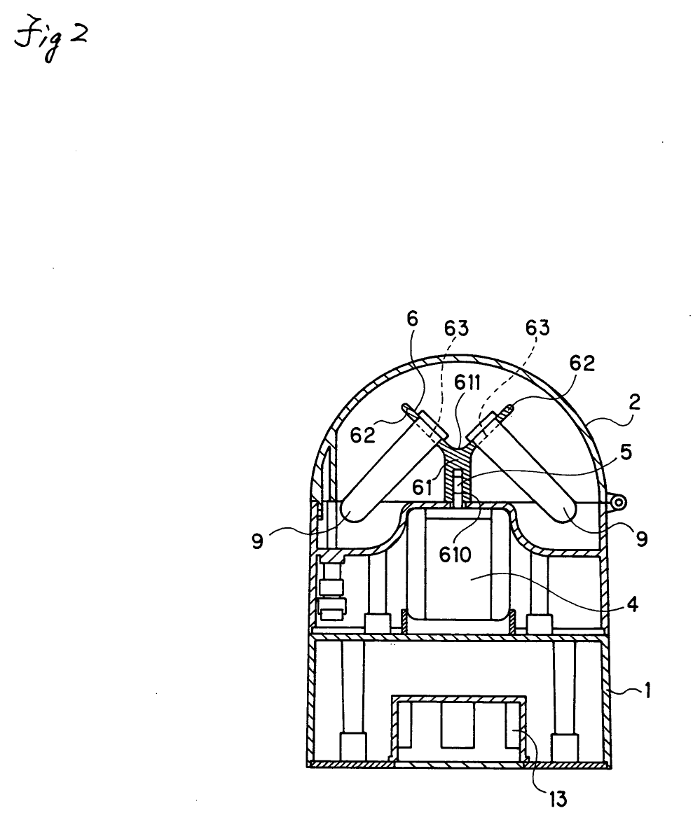

FIG. 2 is a sectional view of the centrifugal separator of FIG. 1, showing a state in which the transparent lid 2 on the main body 1 is closed and the sampling containers 9 are each inserted in the hole 63 of the tongue piece 62 of the sampling-container locking part 6.

The connecting part 61 of the sampling-container locking part 6 has the tongue pieces 62 substantially shaped like shear legs opposed to each other outwardly upward from the upper flat part 611 of the connecting part 61 at and angle of about 45 degrees, wherein the sampling containers 9 are each inserted in the hole 63 of the tongue piece 62.

Referring to FIG. 2, the connecting part 61 and the tongue piece 62 are inclined at about 45 degrees with respect to the upper flat part 611 of the connecting part 61. The tongue pieces 62 are inclined at about 90 degrees with the upper flat part 611 of the connecting part 61 interposed therebetween.

The rotary shaft 5 is fitted in the shaft-inserting part 610 at the center of the connecting part 61. Therefore, the rotary shaft 5 rotates with the rotation of the motor 4 and the connecting part 61 fitted in the rotary shaft 5 also rotates in association therewith, so that the sampling containers 9 inserted in the holes 63 of the sampling-container locking parts 6 rotate around the shaft center of the connecting part 61. The rotation causes blood in each sampling container 9 to be centrifuged toward the bottom of the sampling container 9, thus allowing centrifugal separation.

Also a safety system may be provided to stop power supply to the motor 4 upon the opening of the lid 2 in consideration of safety.

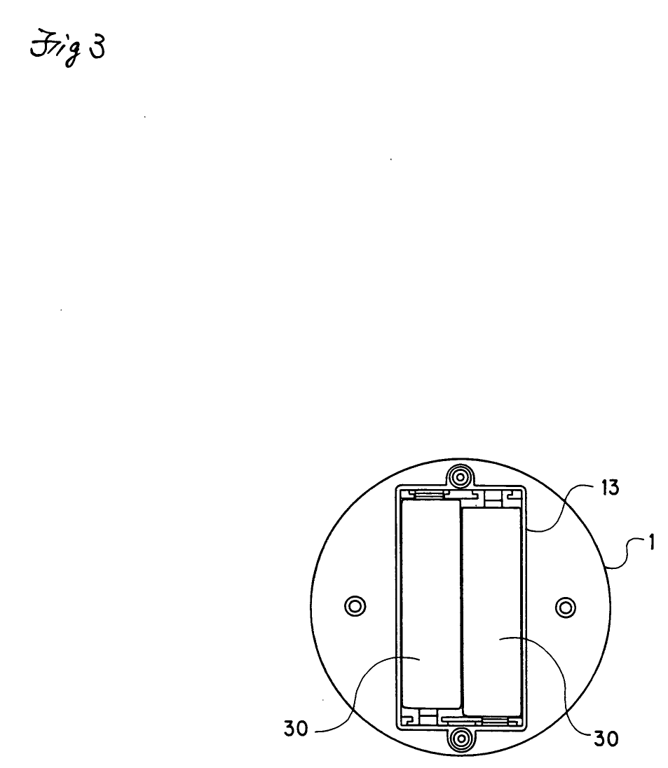

FIG. 3 shows the dry-cell mounting part 13 that is a power-supply container provided at the bottom of the centrifugal separator according to the invention. The motor 4 is driven by, for example, two dry cells 30. This is only an example and may be of one dry cell or, alternatively, three or more dry cells.

As described above, the compact centrifugal separator driven by the dry cell 30 allows centrifugal separation of blood and body fluids, thus allowing simple and reliable sampling.

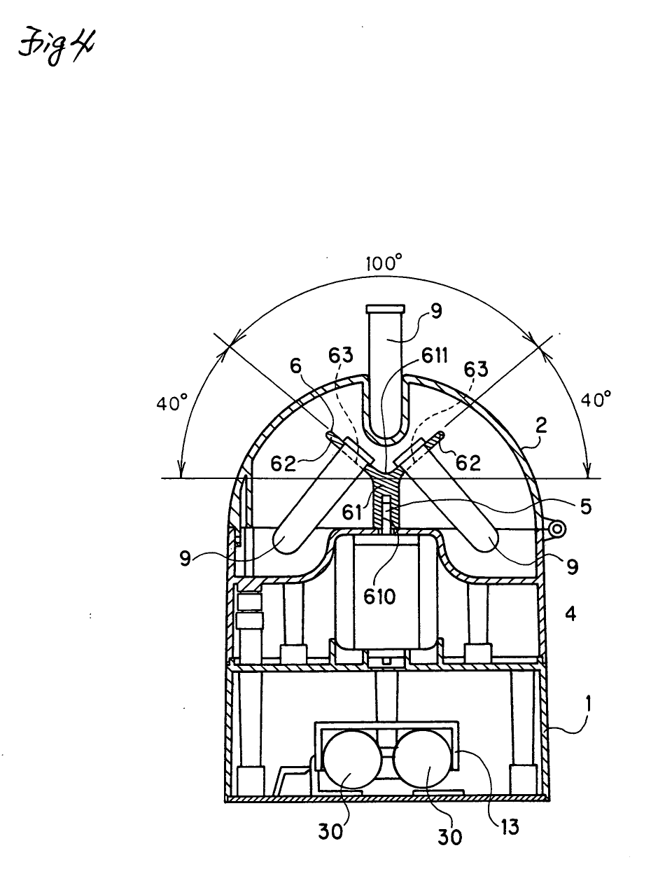

FIG. 4 shows a centrifugal separator according to another embodiment of the present invention, which includes a sampling-container mounting recess 21 on the top of the lid 2, in which the sampling container 9 can be fitted.

The sampling-container mounting recess 21 matches the shape of the bottom of the sampling container 9 and has a recess that can firmly support the bottom of the inserted sampling container 9.

For example, when the sampling container 9 is fitted in the sampling-container mounting recess 21, the opening of the sampling container 9 is directed upward. Accordingly, for example, blood of a finger can be collected from above the opening of the sampling container 9 in the fitted state, so that blood of a finger cut above the opening can be dropped into the sampling container 9.

Of course, it is possible to provide another sampling container 9 separate from that mounted in the main body 1.

The connecting part 61 and the tongue piece 62 in this drawing are inclined at about 40 degrees with respect to the upper flat part 611 of the connecting part 61. The tongue pieces 62 are inclined at about 100 degrees with the upper flat part 611 of the connecting part 61 interposed therebetween, which is different from the example of FIGS. 1 and 2.

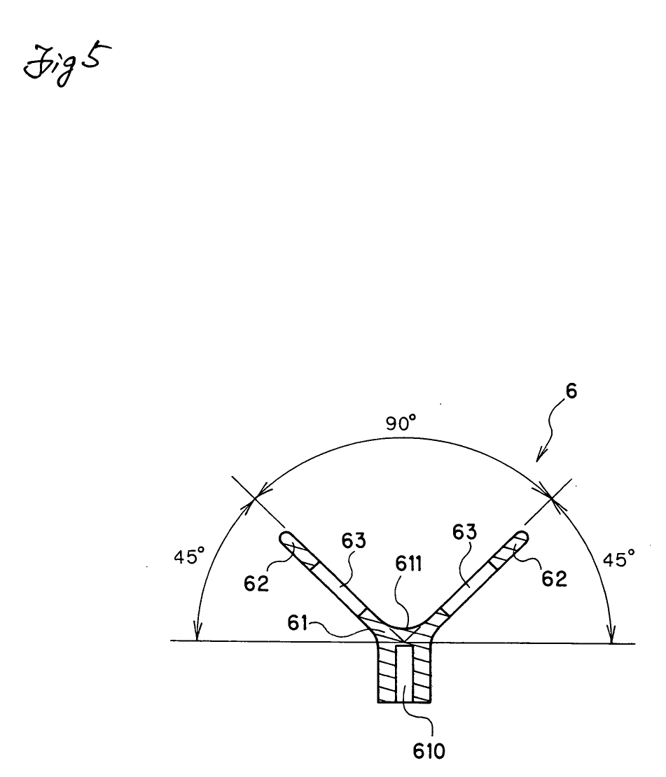

FIG. 5 is a sectional view of the sampling-container locking part 6 shown in FIGS. 1 and 2, which includes the connecting part 61 and the tongue pieces 62 arranged outwardly upward from the upper flat part 611 of the connecting part 61 at an angle of about 45 degrees, the tongue piece 62 being substantially shaped like shear legs opposed to each other with the connecting part 61 as the center. The tongue pieces 62 each have the hole 63 into which the sampling container 9 can be inserted.

The angle is about 45 degrees as an example. However, it is not limited to that and may be any other angles such as about 30, 40, 50, or 60 degrees with respect to the upper flat part 611 of the connecting part 61; at least in the range from about 10 to 60 degrees.

When the tongue piece 62 is parallel with the upper flat part 611, that is, at an angle of zero degree, the sample in the sampling container 9 may be splashed onto the side of the sampling container 9 when centrifuged, and thus the centrifugal force applied to the sample is dispersed. Accordingly, at least a slight inclination is needed, which causes the sample to be centrifuged onto one point of the bottom of the sampling container 9, thus increasing the effect of the centrifugal separation.

On the other hand, setting the inclination at 60 degrees increases the drawbacks similar to those of the flat-installation centrifugal separator and making it difficult to insert and take out the opposed sampling containers 9 into/from the holes 63 of the tongue pieces 62. Therefore, the angle needs to be smaller than that, at most 60 degrees.

As a result of experiment, it was most effective at about 45 degrees and also greatly effective at 30 to 50 degrees.

Preferably, the tongue pieces 62 are arranged at the same angle with respect to the upper flat part 611 of the connecting part 61 and the angle formed by the tongue pieces 62 with the upper flat part 611 interposed therebetween is within the range from about 160 to 60 degrees. More preferably, the angle is within the range from about 120 to 80 degrees for centrifugal separation, and most preferably, at about 90 degrees.

Accordingly, when the sampling container 9 is inserted in the hole 63 of the tongue piece 62, it can be arranged with the opening inclined toward the rotary shaft 5 and the bottom inclined outward, so that the sample gathered on the bottom of the sampling container 9 can be centrifuged to one outward point of the bottom, thereby allowing effective centrifugal separation.

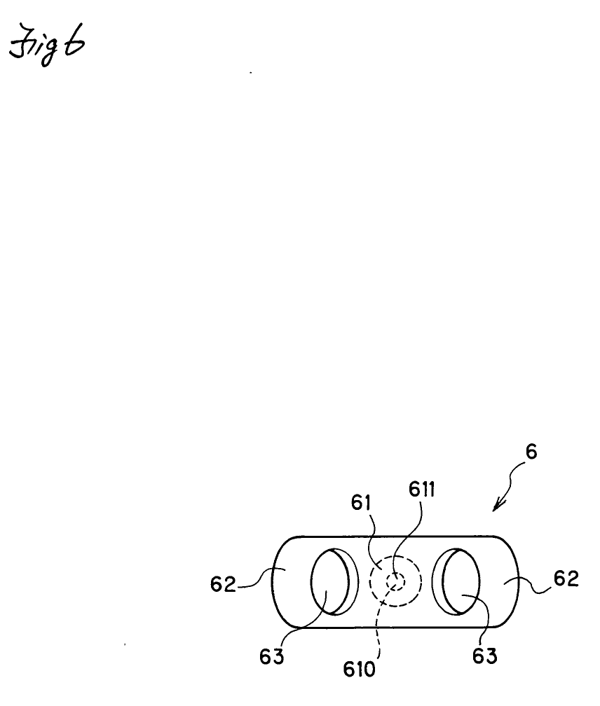

FIG. 6 is a plan view of the sampling-container locking part 6 shown in FIG. 5, viewed from above.

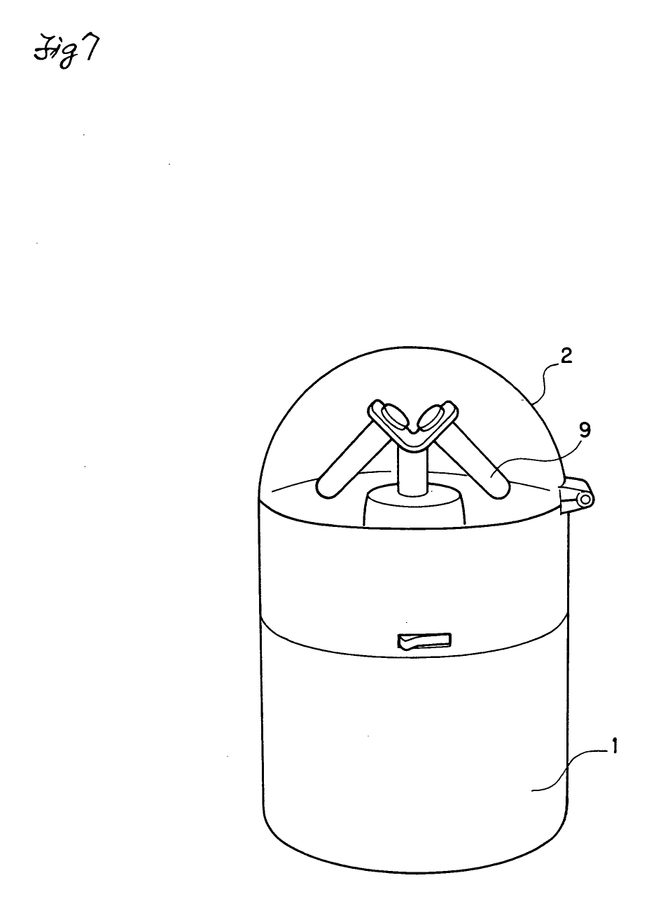

FIG. 7 is a perspective view of an example of the centrifugal separator according to the invention shown in FIGS. 1 and 2, showing a state in which the sampling containers 9 are inserted into the holes 63 in the tongue pieces 62 of the sampling-container locking part 6 with the lid 2 being closed.

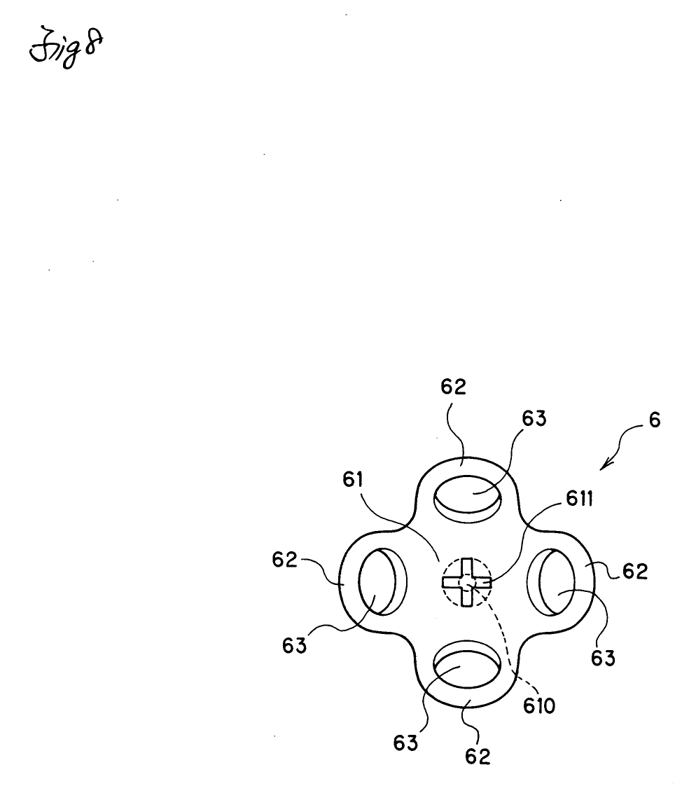

FIG. 8 is a plan view of another example of the sampling-container locking part 6, which includes four tongue pieces 62 at the connecting part 61, each having the hole 63, into which a total of four sampling containers 9 can be fitted.

The tongue pieces 62 are also arranged outwardly upward at an angle of about 45 degrees with respect to the upper flat part 611 of the connecting part 61, which project in pairs oppositely with the connecting part 61 interposed therebetween.

Therefore, when the sampling-container locking part 6 is rotated around the rotary shaft 5, the centrifugal separator can be balanced because the sampling-container locking parts 6 are inserted in the respective holes 63 of the opposite tongue pieces 62, increasing the efficiency of rotation and decreasing the load on the motor 4 to allow efficient centrifugal separation.

In addition, the four sampling containers 9 can be centrifuged at the same time, thus allowing efficient sampling.

The tongue pieces 62 are opposed in pairs and, in FIG. 8, a total of four tongue pieces 62 project 90 degrees apart from one another around the shaft center of the connecting part 61 that fixes the rotary shaft 5.

This allows the opposed two tongue pieces 62 to be balanced in pairs and the four tongue piece 62 to be balanced in four directions with the shaft center as the center.

The invention is not limited to that; while the tongue pieces 62 are opposed in pairs, they may not project at 90 degrees apart from the other two opposed tongue pieces 62.

Specifically, the tongue pieces 62 may be arranged in the form of substantially X-shape with a space not of 90 degrees, but of, for example, 60, 120, 60, and 120 degrees or, alternatively, at other angles apart. At least a pair of opposed tongue pieces 62 have only to be balanced during rotation.

Although the four tongue pieces 62 shown in this drawing have the same size and shape, they are not limited to that; although at least the two opposed tongue pieces 62 have the same size and shape, the other two tongue pieces 62 may be different from those. It is sufficient to balance the two opposed tongue pieces 62. The size and shape include the angle of inclination of the tongue pieces 62.

While FIG. 8 shows the sampling-container locking part 6 having four tongue pieces 62, it is not limited to that; it is sufficient to have an even number of, for example, six tongue pieces 62, and to arrange a pair of tongue pieces 62 oppositely around the shaft center.

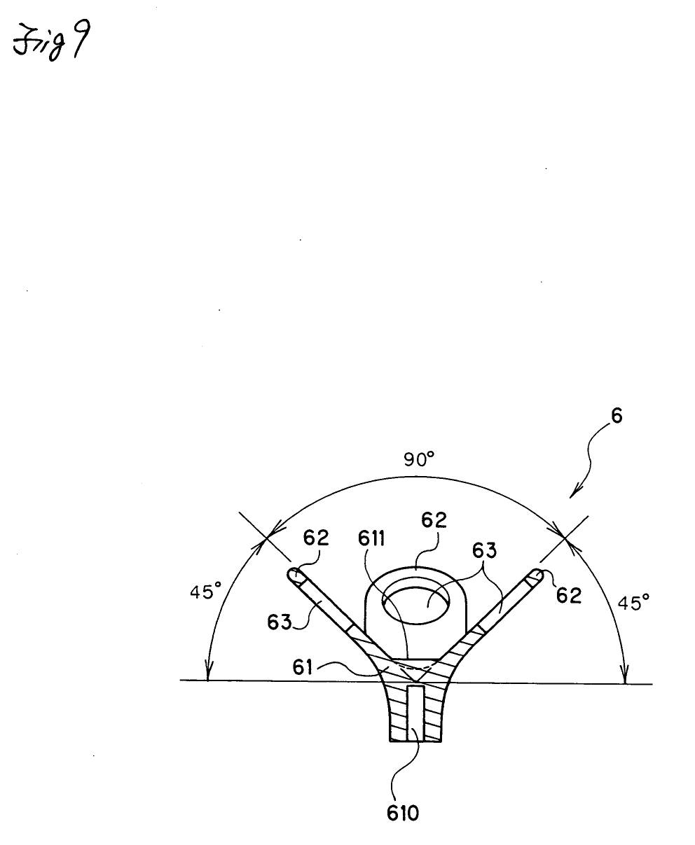

FIG. 9 shows the sampling-container locking part 6 in section. As shown in the drawing, the two tongue pieces 62 are arranged to project at an angle of about 45 degrees oppositely with the connecting part 61 interposed therebetween.

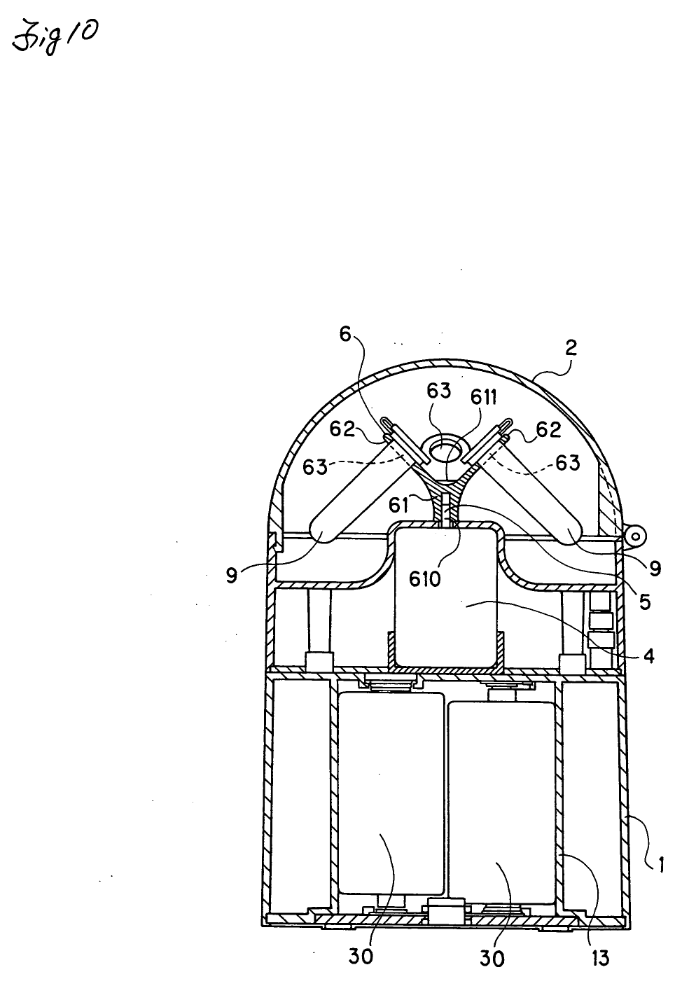

FIG. 10 is a sectional view of a centrifugal separator including the sampling-container locking part 6 having the four tongue pieces 62 shown in FIGS. 8 and 9. As shown in the drawing, the sampling containers 9 can be mounted in balance for centrifugal separation. Each sampling container 9 has a cap for closing the opening.

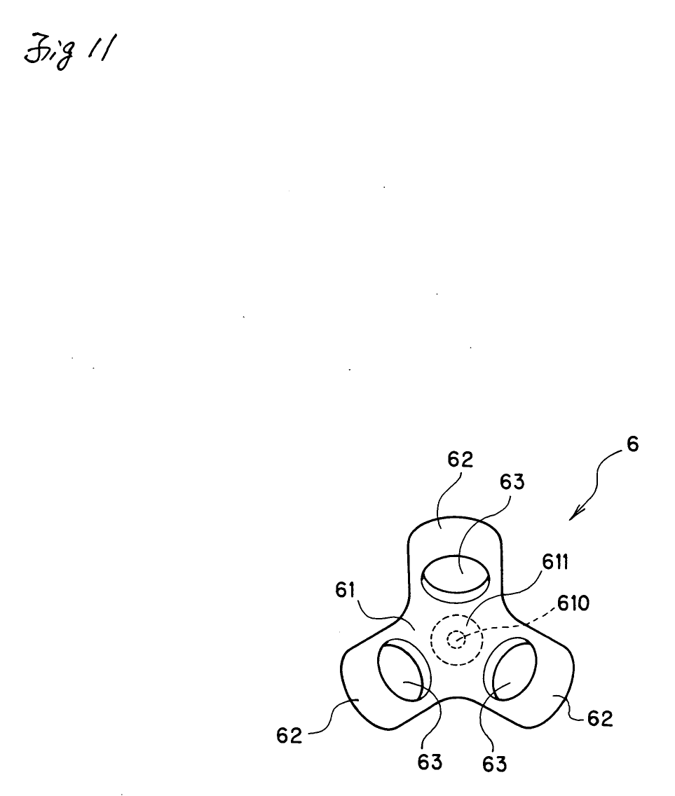

FIG. 11 is a plan view of the sampling-container locking part 6 according to another embodiment of the invention, which includes three tongue pieces 62 in total as an example in which the connecting part 61 has an odd number of tongue pieces 62, each having the hole 63, thus allowing a total of three sampling containers 9 to be mounted.

In this case, the tongue pieces 62 are arranged to project radially at regular intervals in the connecting part 61. Providing the tongue pieces 62 radially at regular intervals allows the tongue pieces 62 to be balanced during rotation.

Although the sampling-container locking part 6 shown in FIG. 11 includes three tongue pieces 62, it may include an odd number of, five or seven, tongue pieces 62 if only arranged to project radially at regular intervals in the connecting part 61.

In this drawing, although the sampling container 9 is locked in the hole 63, it should also be understood that it is not limited to that and the sampling container 9 may be locked with the general locking member 64 having a clamp or a locking piece at the end of each tongue piece 62.

1. The centrifugal separator according to the present invention offers a first advantage in that it can be used with a dry cell, reduced in size, easily manufactured at low cost, used in small-scale medical clinics and for self blood collection to facilitate a blood test and a body fluid test, thus popularizing the blood test and so on.

2. The centrifugal separator according to the present invention offers a second advantage in that, in spite of its compact size, a sampling container can be locked to a sampling-container locking part at an angle, so that a sample can be efficiently gathered on the bottom of the sampling container by centrifugal separation, thus facilitating reliable sampling and further offers the advantage of facilitating efficient collection of blood clots from blood to allow a blood clot test which has not often been performed.

3. The centrifugal separator according to the present invention offers a third advantage in that a plurality of sampling containers can be locked to one centrifugal separator to allow a plurality of or a large number of centrifugal separations at a time, thus achieving efficient sampling.

4. The centrifugal separator according to the present invention offers a great fourth advantage in that the tongue pieces of the sampling-container locking part are arranged to project in opposite directions with the connecting part interposed therebetween or to project radially at regular intervals in the connecting part, thus allowing the centrifugal force to be balanced by the sampling containers locked to the tongue pieces during centrifugal separation, thereby preventing a deviational centrifugal force associated with the rotation to reduce a load on the motor, increasing a centrifugal force to samples in the sampling containers associated with weight reduction and the rotation to allow efficient short-time separation and to facilitate the collection of samples.

5. The centrifugal separator according to the present invention offers a fifth advantage in that a safety system is provided to stop power supply to the motor upon the opening of the lid and the motor can be supplied with power, with the main body covered with the cap, thus providing high safety.

6. The centrifugal separator according to the present invention offers a sixth advantage in that a timer is provided which controls the driving time of the motor to perform centrifugal separation only for optimum time, thus allowing the control of optimum and efficient centrifuging time for centrifugal separation.

7. Particularly, the centrifugal separator according to the present invention offers a seventh advantage in that it can be used for centrifugal separation of human blood and body fluids and also for a blood test and a body fluid test of animals including domestic animals, leading to early detection of the diseases of animals and safety of edible animals and expanding the blood test for animals including domestic animals which has not been performed in view of cost and labor.

The invention further offers the advantage in that test objects other than the body fluids and blood which require centrifugal separation to obtain sample for tests or experiments can be easily centrifuged anywhere. Furthermore, the centrifugal rotation in place of the centrifugal separation allows the mixing of the test object in the sampling container.

8. The centrifugal separator according to the present invention offers an eighth advantage in that it is very compact and lightweight, has excellent usability because it can be used in the place without a power supply, for example, a 100-V power supply but with a dry cell and it can easily be controlled at hand, and can be used not only for the separation of blood and body fluids but also for various purposes, thus providing remarkably wide range of applications.

1. A centrifugal separator comprising:
a main body including a motor and a dry cell serving as a driving power supply; and
a sampling-container locking part connected to the rotary shaft of the motor and capable of locking a sampling container, the sampling container locked to the sampling-container locking part being rotated by the rotation of the motor;
wherein the sampling-container locking part comprises: a connecting part capable of connecting to the rotary shaft; and tongue pieces projecting oppositely with the connecting part interposed therebetween; and
wherein the tongue pieces are arranged to project from the upper flat part of the connecting part at an angle of at least about 10 to 60 degrees and each have a hole capable of locking the sampling container.

2. A centrifugal separator according to claim 1, wherein the tongue pieces projecting oppositely with the connecting part interposed therebetween have the same shape.

3. A centrifugal separator according to claim 1, wherein the tongue pieces projecting oppositely with the connecting part interposed therebetween are at least a pair of tongue pieces.

4. A centrifugal separator comprising:
a main body including a motor and a dry cell serving as a driving power supply; and
a sampling-container locking part connected to the rotary shaft of the motor and capable of locking a sampling container, the sampling container locked to the sampling-container locking part being rotated by the rotation of the motor,
wherein the sampling-container locking part comprises: a connecting part capable of connecting to the rotary shaft; and an odd number of tongue pieces projecting from the connecting part;
wherein the odd number of tongue pieces are arranged to project radially at regular intervals in the connecting part; and
wherein the tongue pieces are arranged to project from the upper flat part of the connecting part at an angle of at least about 10 to 60 degrees and each have a hole capable of locking the sampling container.

5. A centrifugal separator according to claim 1, wherein the projecting tongue pieces have the same shape.

6. A centrifugal separator according to claim 1, comprising a locking member capable of locking the sampling container in place of the hole capable of locking the sampling container.

7. A centrifugal separator according to claim 1, wherein the tongue pieces are arranged to project from the upper flat part of the connecting part at an angle of at least about 45 degrees.

8. A centrifugal separator according to claim 1, wherein the main body further comprises: an openable and closable lid for closing the sampling-container locking part connected to the rotary shaft; and a safety system that stops power supply to the motor upon the opening of the lid and is capable of power supply to the motor with the main body covered with the lid.

9. A centrifugal separator according to claim 1, further comprising a timer for controlling motor driving time to stop the driving of the motor after a lapse of a specified time interval from the start of motor driving, thereby completing centrifugal separation.

10. A centrifugal separator according to claim 1, wherein the centrifugal separator is a blood centrifugal separator.

11. A centrifugal separator according to claim 1, wherein the centrifugal separator is a body-fluid centrifugal separator.

12. A centrifugal separator according to claim 10, wherein the centrifugal separator is a blood centrifugal separator for the blood of animals including domestic animals.

13. A centrifugal separator according to claim 11, wherein the centrifugal separator is a body-fluid centrifugal separator for the body fluids of animals including domestic animals.
